(19) United States
(12) Patent Application Publication
(10) Pub. No.: US 2021/0404072 A1
(43) Pub. Date: Dec. 30, 2021

(54) HYDROGEN SEPARATION SYSTEM AND METHOD THEREFOR

(71) Applicant: Jonathan Jan, Culver CIty, CA (US)

(72) Inventor: Jonathan Jan, Culver CIty, CA (US)

(21) Appl. No.: 17/353,116

(22) Filed: Jun. 21, 2021

Related U.S. Application Data
(60) Provisional application No. 63/043,351, filed on Jun. 24, 2020.

(51) Int. Cl. C25B 9/50; C25B 1/04; C25B 9/19; C25B 13/07; C25B 13/08; C25B 13/02; C25B 11/087; C25B 11/069; C25B 11/052

(52) U.S. Cl. CPC C25B 9/50; C25B 1/04; C25B 9/19; C25B 13/07; C25B 11/052; C25B 13/02; C25B 11/087; C25B 11/069; C25B 13/08

(57) ABSTRACT

A device for hydrogen separation has a tank holding water. A membrane is attached to an open top of the tank. A portion of the membrane is immersed in the water of the tank and outer edges of the membrane are attached to the tank and above the water. A pair of electrodes is coupled to the outer edges of the membrane. A light source is positioned above the water, wherein the light excites the water on top of the membrane causing H₂ to be released.

### RELATED APPLICATIONS

This patent application is related to U.S. Provisional Application No. 63/043,351 filed Jun. 24, 2020, entitled “HYDROGEN SEPARATION SYSTEM AND METHOD THEREFOR” in the name of Jonathan Jan, and which is incorporated herein by reference in its entirety. The present patent application claims the benefit under 35 U.S.C § 119(e).

### TECHNICAL FIELD

The present application relates generally to alternative fuel systems and methods, and more specifically, to a system and method for hydrogen separation which uses light to split water into hydrogen and oxygen.

### BACKGROUND

As global warming and related environmental issues become more serious the development of renewable energy sources is becoming more important. Hydrogen has been commonly accepted as one of the cleanest fuels for energy production. Hydrogen can be easily converted into various forms of energy such as heat, power and electricity, and it does not produce substances other than water even when consumed. Thus, hydrogen is considered promising as a next generation clean energy media.

There are several technologies available for hydrogen production, including reforming, decomposition, and hydrolysis of fossil fuels. Presently, the vast majority of hydrogen production may be derived from fossil fuel. Traditionally, hydrogen has been produced from petroleum refineries. Unfortunately, the hydrogen produced may be contaminated with carbon-monoxide and other impurities. Such hydrogen is not suitable for fuel cells because a sulfonated tetrafluoroethylene-based fluoropolymer-copolymer, known by the brand name Nafion may be destroyed. Nafion has received a considerable amount of attention as a proton conductor for proton exchange membrane (PEM) fuel cells due to its excellent thermal and mechanical stability.

Thus, it would be desirable to find a method of producing pure hydrogen that does not contain the impurities found through hydrogen production via fossil fuels. One common method of producing “pure” hydrogen is a hydrolysis process by splitting water with DC electricity. Unfortunately, the cost is high, and there are still impurities from the electrolysis cat-ion. Further purification is needed in order for it to be used in feed into fuel cells.

Therefore, it would be desirable to provide a method of producing pure hydrogen. The method would use sunlight to split water into hydrogen and oxygen upon a photoelectric effect.

### SUMMARY OF THE INVENTION

In accordance with one embodiment, a device for hydrogen separation is disclosed. The device has a tank holding water. A membrane is attached to an open top of the tank, wherein a portion of the membrane is immersed in the water of the tank and outer edges of the membrane are attached to the tank and above the water. A pair of electrodes is coupled to the outer edges of the membrane. A light source is positioned above the water, wherein the light excites the water on top of the membrane releasing H₂.

In accordance with one embodiment, a device for hydrogen separation is disclosed. The device has a tank holding water. A concave membrane is attached to an open top of the tank, wherein a portion of the concave membrane is immersed in the water of the tank and outer edges of the concave membrane are attached to the tank and above the water. A pair of electrodes is coupled to the outer edges of the membrane. A light source is positioned above the water, wherein the light excites the water on top of the membrane releasing H₂.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a perspective view of a prior art system showing photoelectric effect;

FIG. 2 is a perspective view of a prior art system for producing hydrogen; and

FIG. 3 is a perspective view of an exemplary system for producing hydrogen in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

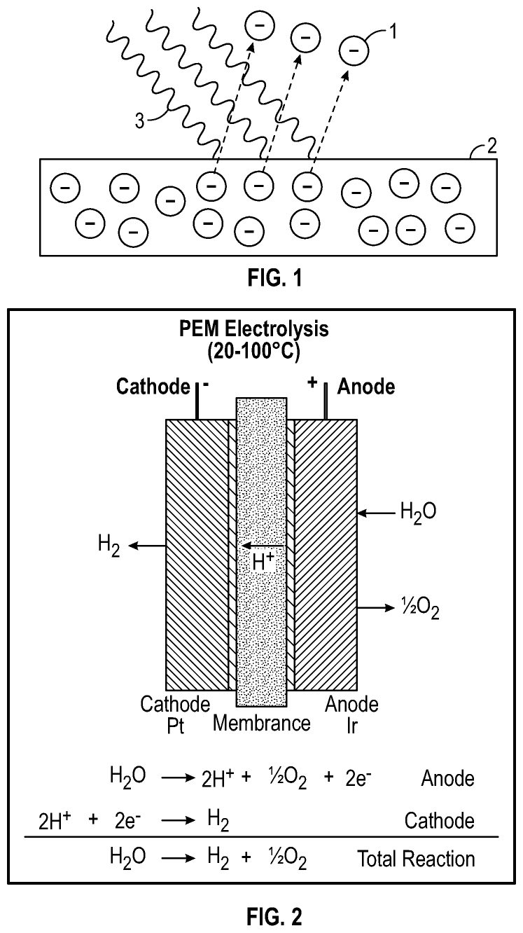

Refining to FIG. 1, the photoelectric effect is a phenomenon where electrons 1 may be emitted from a surface 2 when the light 3 of sufficient frequency is incident upon. Electrons emitted in this manner may be called photoelectrons. According to classical electromagnetic theory, the photoelectric effect can be attributed to the transfer of energy from the light to an electron. From this perspective, n alteration in the intensity of light induces changes in the kinetic energy of the electrons emitted from the surface material. According to this theory, a sufficiently dim light is expected to show a time lag between the initial shining of its light and the subsequent emission of an electron.

But the experimental results did not correlate with either of the two predictions made by classical theory. Instead, experiments showed that electrons may be dislodged only by the impingement of light when it reached or exceeded a threshold frequency. Below that threshold, no electrons may be emitted from the material, regardless of the light intensity or the length of time of exposure to the light.

In Albert Einstein's photoelectric model, light may be composed of discrete quanta, now called photons, rather than continuous waves. By assuming that light actually consisted of discrete energy packets, Einstein wrote an equation for the photoelectric effect. Einstein theorized that the energy of each quantum of light may be the frequency of light multiplied by Planck's constant. A photon above the threshold frequency may have the required energy to eject an electron from the target.

Photoelectric effect may occur in water under sunlight. But the local hydrogen and oxygen react immediately and return back to water, while releasing heat. This may be evident since the heat of the water under sunlight far exceeds the thermal energy from the infrared (IR) radiation from the sunlight.

The discovery of the Fourth Phase of Water by Prof. Gerald Pollack opened a new quantum mechanics venue for splitting water, which may be the fundamental mechanism of plants' photosynthesis. The Forth Phase of Water may be defined as the Exclusion Zone (EZ) found at the boundary. This may be made up of several molecules thick structured water, i.e., liquid crystal. The EZ has crystalline-like lattice that may have a positive charge on one side with negative charge on the other. This architecture may enable one to break water's H—O bond with incident light, while keeping hydrogen separate from oxygen.

The water disassociation reaction may be defined as follows:

H₂O→2H⁺+2e⁻+O₁

In sunlight spectrum, infrared (IR) may have a wavelength of approximately 700-1000 nm, near infrared (NIR) may have a wavelength between 780-4000 nm. The energy may range between 1.2-1.8 eV. Ultraviolet (UV) may range between 10-400 nm with energy of 3.9-14 eV.

It may take approximately 12.56 eV to ionize the first electron from the molecule in bulk water. However, when EZ water is expanded with IR & NIR, it may only take 5.2 eV to break the H—O bond. This can easily be accomplished by irradiating the EZ with UV from sunlight.

Oxygenated water O—H—O—H aka ozone water may be useful for water treatment and is a strong oxygenating agent for many chemical processes. Traditional electrolysis process is totally different from the present embodiment disclosed below. Polymer electrolyte membrane (PEM) electrolysis may be defined as the electrolysis of water in a cell equipped with a solid polymer electrolyte as shown in FIG. 2. Alkaline solution may be prepared in order to make the bulk water electrically conductive. Electrodes (i.e., Cathode − and anode +) may be immersed in the water solution. In order to pass DC voltage and current throughout the bulk water, a lot of energy may be consumed in order to overcome the internal resistivity of the bulk water solution. It has been proposed to add a Nafion PEM between the electrodes to promote the ion exchange. The EZ around the PEM adds local voltage and improves the electrolysis efficiency. But the modified electrolysis is fundamentally different from the quantum mechanical art proposed below.

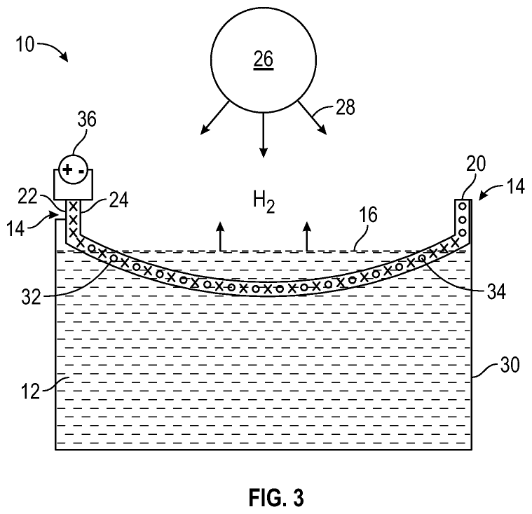

Referring to FIG. 3, an apparatus 10 for separating hydrogen from water may be shown. The apparatus 10 may have a tank 30 for holding water 12. A membrane 20 may be attached to the tank 30 so as to be partially immersed in the water 12. The membrane 20 may be concave in shape such that the membrane 20 curves down inwardly into the water 12 with the outer edges 14 of the membrane 20 positioned above the waterline 16. Electrodes 18 may be attached to the edges 14 of the membrane 20 positioned above the waterline 16. A positive electrode + 22 may be attached to an exterior of the edge 14 of the membrane 20 above the waterline 16. A negative electrode − 24 may be attached to an interior of the edge 14 of the membrane 20 above the waterline 16. A light source 26 may be positioned above the water 12. The light source 26 may be natural light such as sunlight or artificial light of specific wavelengths.

In operation, the light rays 28 emanating from the light source 26 excites the EZ water 12A on top of the membrane 20, causing hydrogen H₂ to be released. Oxygen atom O₁ may be dissolved and combined with water molecules outside of the membrane 20.

In order to keep the disassociated hydrogen, separate from oxygen, the membrane 20 may be a permeable non-conductive membrane. The membrane 20 can be a polymer or ceramic membrane. In accordance with one embodiment, the membrane 20 may be formed of diatomite ceramic. Diatomite ceramic has pores which may act as a water filter. The diatomite also has intrinsic electrostatic properties.

The polymer or ceramic membrane can also be coated with Nafion. Nafrion has the unique characteristic of boosting EZ and proton exchange.

An electrostatic voltage 36 may be applied via the electrodes 18 to the edges 18 of the membrane 20 above the waterline 16. Thus, there is no direct contact of the water 12 with the electrodes 18. This electrostatic voltage promotes the momentum of the protons to rise to the water surface and form hydrogen gas, while oxygenated water is pushed to the other side of the membrane.

Additionally, Carbon Nano tube (CNT) 32 can be incorporated in the membrane 20 to accelerate the ionic flow. Catalysts like Titanium-dioxide (TiO₂) 34 may also be applied to the membrane to boost the photoelectric effect.

The light source 26 may be natural light such as sunlight or artificial light of specific wavelengths. In an environment with no sunlight, artificial light sources can be applied for this reaction. Preferred light sources may be UVA, 315-400 nm, and NIR 3.1 micron. The combination of these may provide maximum yield. In accordance with one embodiment, remote solar concentrators can be adapted to deliver high intensity light source via fiberoptics to the apparatus 10.

The apparatus 10 may provide a low-cost system and method for hydrogen separation which uses light to split water into hydrogen and oxygen. The light rays 28 emanating from the light source 26 may allow for a quantum optical reaction to knock out H+ which merge into H2 when capturing electrons in the EZ. O1 bonds to H2O and pass through the membrane 20 into the water 12 in the tank 30.

The foregoing description is illustrative of particular embodiments of the application, but is not meant to be a limitation upon the practice thereof. The following claims, including all equivalents thereof, are intended to define the scope of the application.

What is claimed is:

1. A device for hydrogen separation, comprising:
a tank holding water;
a membrane attached to an open top of the tank, wherein a portion of the membrane is immersed in the water of the tank and outer edges of the membrane are attached to the tank and above the water;
a pair of electrodes coupled to the outer edges of the membrane; and
a light source positioned above the water, wherein the light excites the water on top of the membrane releasing H₂.

2. The device of claim 1, comprising an electrostatic voltage coupled to the electrodes.

3. The device of claim 1, wherein the membrane is permeable and non-conductive.

4. The device of claim 1, comprising carbon nano-tubes formed within the membrane.

5. The device of claim 1, comprising a Nafrion coating applied to the membrane.

6. The device of claim 1, comprising titanium-dioxide (TiO₂) applied to the membrane.

7. The device of claim 1, wherein the membrane is one of a polymer membrane or ceramic membrane.

8. The device of claim 1, wherein the membrane is a diatomite ceramic membrane.

9. The device of claim 1, wherein the light source is an artificial light source.

10. The device of claim 9, wherein the artificial light source provides light waves in UVA range of 315-400 nm and NIR range of 3.1 microns.

11. A device for hydrogen separation, comprising:
a tank holding water;
a concave membrane attached to an open top of the tank, wherein the concave membrane extends down and is immersed in the water of the tank and outer edges of the concave membrane are attached to the tank and above the water;
a pair of electrodes coupled to the outer edges of the membrane; and
a light source positioned above the water, wherein the light excites the water on top of the membrane releasing H₂.

12. The device of claim 11, comprising an electrostatic voltage coupled to the electrodes.

13. The device of claim 11, wherein the membrane is permeable and non-conductive.

14. The device of claim 11, comprising carbon nano-tubes formed within the membrane.

15. The device of claim 11, comprising a Nafrion coating applied to the membrane.

16. The device of claim 11, comprising titanium-dioxide (TiO₂) applied to the membrane.

17. The device of claim 11, wherein the membrane is one of a polymer membrane or a ceramic membrane.

18. The device of claim 11, wherein the membrane is a diatomic ceramic membrane.

19. The device of claim 11, wherein the light source is an artificial light source.

20. The device of claim 119, wherein the artificial light source provides light waves in UVA range of 315-400 nm and NIR range of 3.1 microns.
